(19) United States
(12) Patent Application Publication
(10) Pub. No.: US 2005/0051476 A1
(43) Pub. Date: Mar. 10, 2005

(54) Filtering device for a portable beverage container

(76) Inventors: Tsao-Shin Chen, Taipei (TW); Yung-Chi Chen, Taipei (TW)

Correspondence Address: Jackson Walker L.L.P.;Suite 2100, 112 E. Pecan Street, San Antonio, TX, 78205, US

(21) Appl. No.: 10/659,140

(22) Filed: Sep. 10, 2003

(51) Int. Cl. B01D 35/28

(52) U.S. Cl. 210/436; 210/450; 210/472

(57) ABSTRACT

A filtering device for a portable beverage bottle has a cap with a suction tube adapted to detachably mount on an opening of the beverage bottle, and at least one filter element detachably secured below the cap. The at least one filter element is accommodated inside the portable beverage to purify water conveniently. Additionally, a movable hat is attached on the suction tube to selectively close or open the filtering device.

### BACKGROUND OF THE INVENTION

1. Field of the Invention

The invention relates to a filtering device for a portable beverage container, and particularly for various existing plastic beverage bottles to filter impure water conveniently.

2. Description of Related Art

In recent years, beverage containers have been mostly made from plastic because plastic-molding technology has become mature. However, the plastic beverage bottles are not environmentally friendly, thus people like to reuse the plastic beverage bottles to store water for drinking when going out, instead of discarding them shortly after purchase. For health reasons, people pay a lot of attention to the safety of drinking water, especially to water of doubted quality obtained from outdoor environment.

Such a situation usually happens to mountain climbers and hikers. When the climber stays in mountains for several days, a lot of potable water is needed but carrying it causes an excessive weight burden on the climber. However, if the climber obtains water from mountain streams, the water may not be safe for drinking, whereby the climber may be caught between a rock and a hard place in that humans need plenty of clean water but that water is too heavy.

The present invention has arisen to provide a filtering device for a portable beverage container to overcome and obviate the drawbacks.

### SUMMARY OF THE INVENTION

A first objective of the present invention is to provide a filtering device for a portable beverage bottle to conveniently purify water at any place and at any time to ensure that the water is potable.

Further benefits and advantages of the present invention will become apparent after a careful reading of the detailed description in accordance with the drawings.

### BRIEF DESCRIPTION OF THE DRAWINGS

FIG. 1 is an exploded plane view of a filtering device for a portable beverage container in accordance with the present invention;

FIG. 2 is a side plane view of the filtering device in assembly;

FIG. 3 is a partially enlarged side plane view of the filtering device showing a cap attached on a beverage bottle;

FIG. 4 is an operational side plane view of the filtering device when the cap is opened to permit drinking of water;

FIG. 5 is an operational side plane view of the filtering device when the cap is closed;

FIG. 6 is an operational side plane view of the filtering device, wherein the cap is directly attached to a suction tube;

FIG. 7 is an operational side plane view of the filtering device, wherein the cap with a filter element is attached to the suction tube;

FIG. 8 is a top plane view of the cap of the filtering device;

FIG. 9 is a side plane view of another embodiment showing the engaging means between two filter elements;

FIG. 10 is a bottom plane view of the filter element; and

FIG. 11 is a side plane view of still another embodiment showing the engaging means between two filter elements.

### DETAILED DESCRIPTION OF THE PREFERRED EMBODIMENT

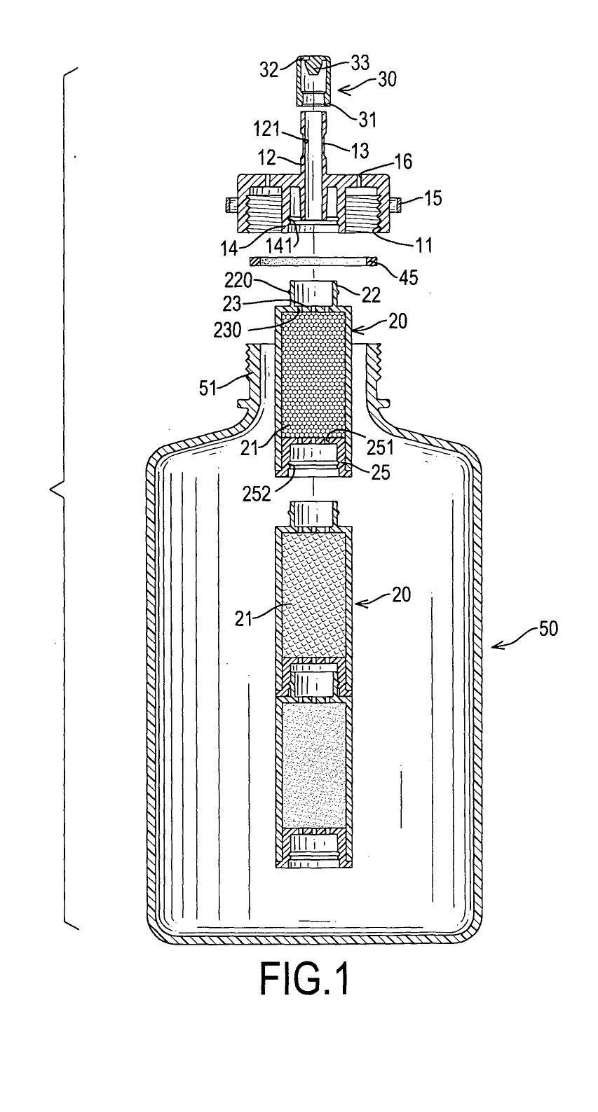

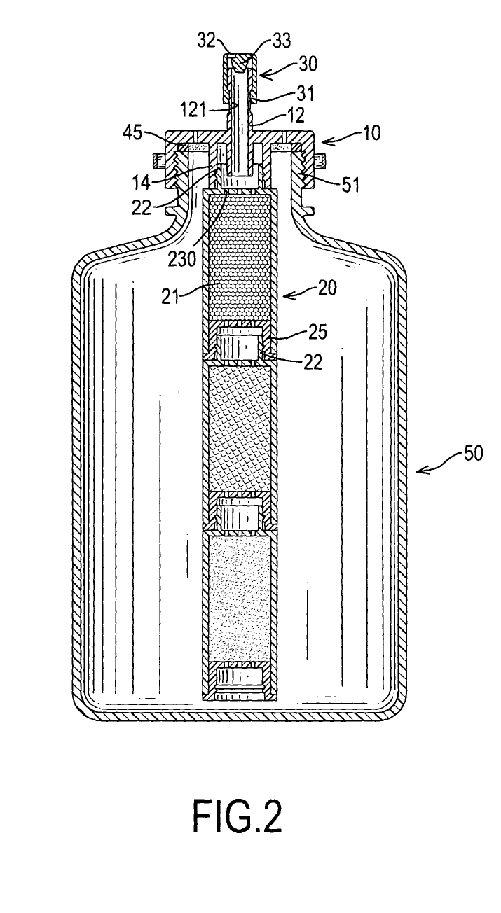

With reference to FIGS. 1 and 2, a filtering device in accordance with the present invention is adapted to mount on a beverage container, such as polyester plastic bottle of 600 c.c. or 1000 c.c. volume in standardization. The filtering device comprises a cap (10) adapted to mount on a plastic bottle (50) and at least one filter element (20).

The cap (10) is adapted to mount on the plastic bottle (50) by means of thread and has a top face, a bottom face, a suction tube (12) extending from the top face, a recess (not numbered) defined in the bottom face, a connecting tube (14) formed on the bottom face inside the recess, and multiple ventilating holes (16) defined through the cap (10). The suction tube (12) with a flow channel (121) has a first end (not numbered), a middle section (not numbered), and a limiting cutout (13) defined in the middle section, and a movable hat (30) mounted on the first end to close the flow channel (121). The suction tube (12) further has a second end (not numbered) extending inside the recess within the connecting tube (14), thus a gap is defined between the second end of the suction tube (12) and the connecting tube (14). The movable hat (30) is cylindrical and has a round top (not numbered), an opening (not numbered), a side wall (not numbered) with an inner periphery around the round top, a water outlet (32) defined through the round top, and a tab (31) formed on the inner periphery of the side wall. When the movable hat (30) mounts on the suction tube (12), the opening faces toward the suction tube (12) and parts of the suction tube (12) are received inside the movable hat (30). The tab (31) is slidably engaged with the limiting cutout (13) to allow the movable hat (30) to slide along the suction tube (12) to open or close the suction tube (12). Additionally, a plug (33) is formed under the round top to hermetically block the flow channel (121) when the movable hat (30) closes the suction tube (12).

Because the plastic beverage bottle (50) has a threaded opening (51) in standardization, the recess with an inner side face has a thread (11) defined on the inner side face to correspond to the threaded opening (51) to make the engagement of the cap (10) easy and convenient to various beverage bottles. Moreover, an O-ring (45) is attached on the bottom face within the recess to seal up the beverage bottle (50) when the cap (10) mounts on the threaded opening (51).

Each filter element (20) is adapted to accommodate inside the plastic beverage container (50) and is composed of a hollow cylinder shell (not numbered) and a filtering material (21) filling inside the shell. The shell has a top (23), a bottom end, an adjacent tube (22) formed on the top (23), and a bottom cover (25) attached to the bottom end of the shell to enclose the filtering material inside the shell. The adjacent tube (22) wedges into the gap between the connecting tube (14) and the second end of the suction tube (12) and has an outer side face (not numbered) and an annular protrusion (220) formed on around outer side face. Correspondingly, the connecting tube (14) has an inner side face (not numbered) and an annular cutout (141) defined around the inner side face to engage with the annular protrusion (220). Whereby, the filter element (20) is tightly combined with the cap (10) by means of wedges. The bottom cover (25) is a cap-shaped body welded inside the shell at the bottom end thereof and has a round top (not numbered) and a side wall (not numbered) formed around the round top to define a notch (not numbered) and an opening (not numbered). The side wall has an outer periphery and an inner periphery. An annular cutout (252) is formed on the inner periphery of the side wall within the notch to engage with the annular protrusion (220) of the adjacent tube (22) of an adjacent filter element. Whereby, multiple filter elements (20) are enabled to combine together in sequence by means of wedges. Multiple top holes (230) are defined through the top (23) of the shell and multiple bottom holes (251) are defined through the bottom cover (25) to allow water to pass through the filter material via the holes (230,251).

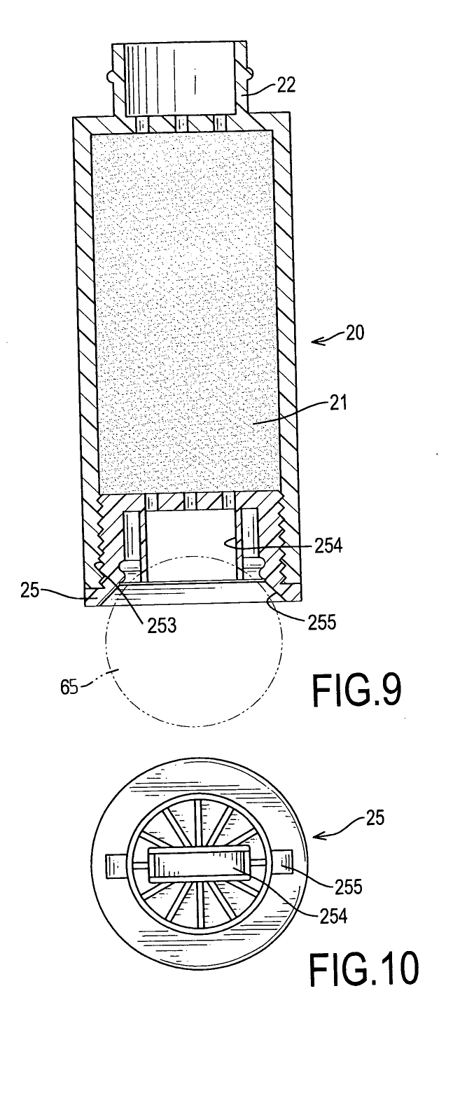

With reference to FIGS. 9 and 10, in order to change the filtering material (21) inside the shell, the bottom cover (25) is modified to have a thread (253) formed on the outer periphery of the side wall and the shell also has a thread (not numbered) formed on an inner wall at the bottom end of the shell. Whereby, the bottom cover (25) is engaged with the shell by means of threads. Moreover, a rectangular slit (254) having two long sides (not numbered) and two short sides (not numbered) is formed under the round top, wherein each short sides has a dent defined at a distal edge of the short side. A pair of inclined cutouts (255) are oppositely defined in edges around the opening in alignment with the two short sides. Thus, the bottom cover (25) is enabled to detach from the shell by a user inserting a coin (65) into the slit (254) via the inclined cutouts (255) and the dents on the two short sides to drive the bottom cover (25) rotate. Additionally, the filtering material (21) is selected from different materials such as active carbon, high-density cotton core, purifying mineral, ionic magnetite etc.

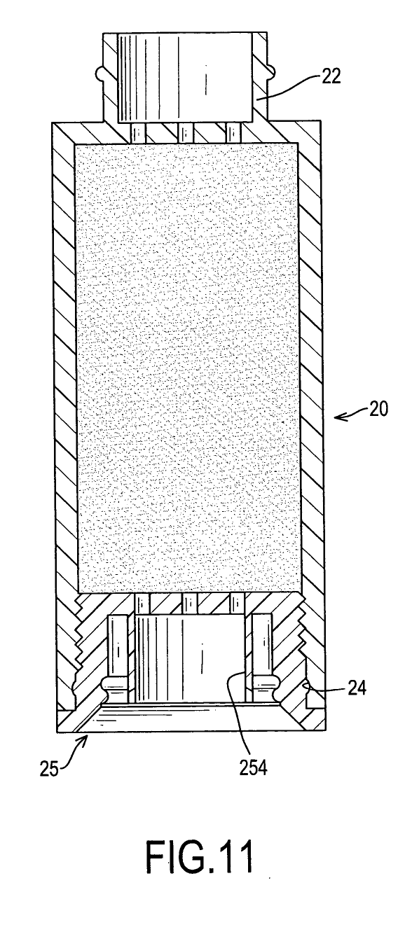

With reference to FIG. 11 showing another embodiment of the bottom cover (25), a shallow dent (24) is defined in an inner periphery of the shell near the bottom of the filter element (20) and a slightly bump (not numbered) is formed on the outer periphery of the side wall to engage with the shallow dent (24). Whereby, the bottom cover (25) is detachably engaged with the bottom end of the shell by means of threads and wedge at the same time to provide extra sealing and positioning efficiency for the bottom cover (25).

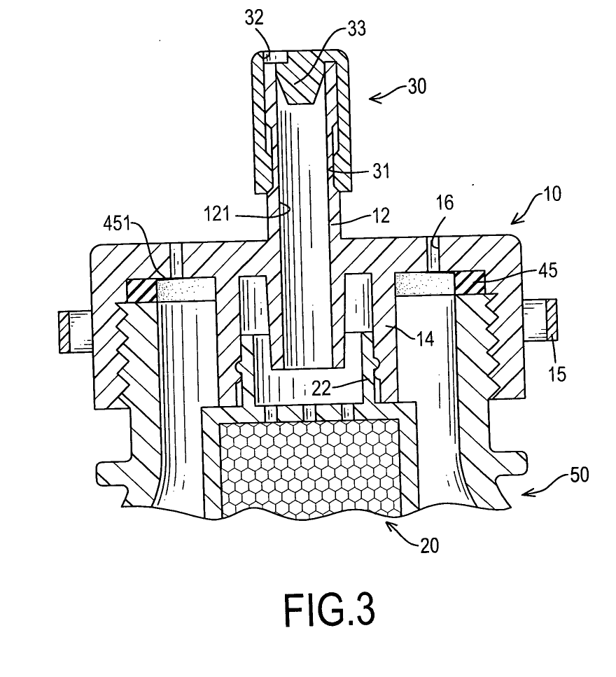

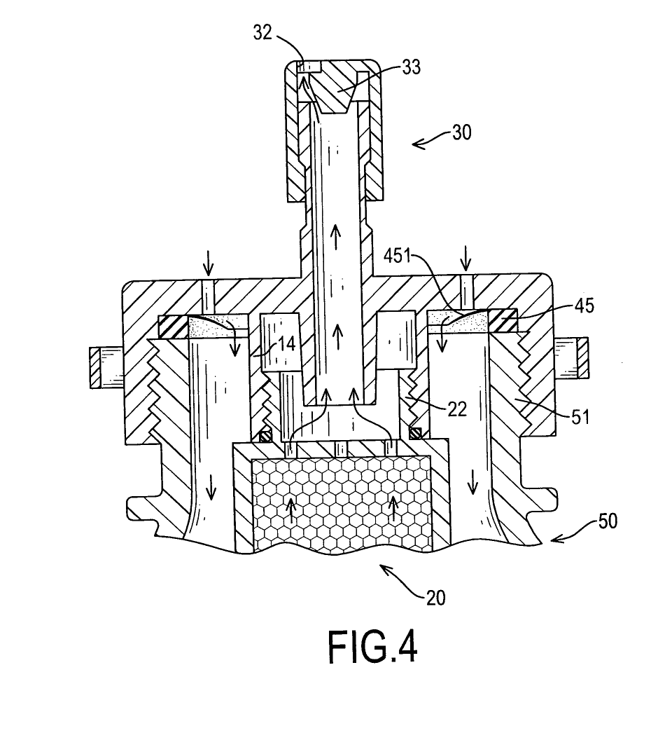

With reference to FIGS. 3 and 4, the cap (10) attaches on the threaded opening (51) of the plastic beverage bottle (50). The O-ring (45) further has a membrane (451) extending along the bottom face of the cap (10) to cover the ventilating holes (16), whereby water inside the plastic beverage container (50) does not leak out via the ventilating holes (16). When the filtering device operates, the movable hat (30) is pulled up to move the plug (33) away from the flow channel (121). Then, a pumping force provided by a user sucking the suction tube (12) attracts water to pass through the filter elements (20), meanwhile, the membrane (451) automatically detaches from the ventilating holes (16) to balance the pressure inside the plastic beverage container (50). After passing through the filter elements (20), the water is purified and flows out via the flow channel (121) and the water outlet (32) of the movable hat (30).

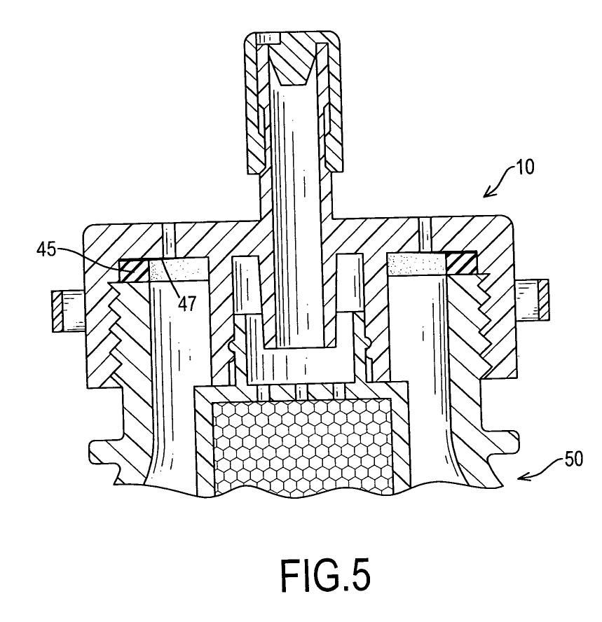

With reference to FIG. 5, another embodiment of the cap (10) has a singular membrane (47) simply clamped between the bottom face of the cap (10) and the plastic beverage bottle (50).

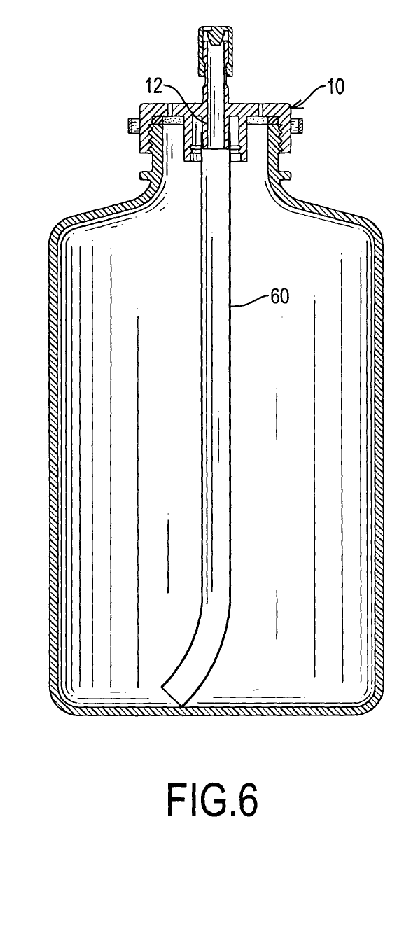

FIG. 6 shows another operational embodiment of the filtering device, wherein the cap (10) is enabled to directly connect with a resilient tube (60) at the second end of the suction tube (12) without any filter element (20).

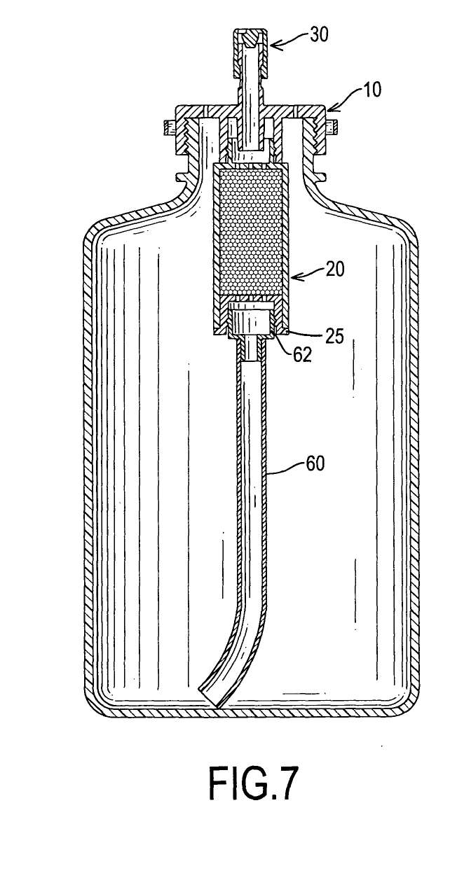

FIG. 7 shows still another operational embodiment of the filter device in accordance with the present invention, wherein the cap (10) combines with one filter element (20) and the resilient tube (60). The resilient tube (60) further has a connecting head (62) attaching to the bottom cover (25) by means of threads or wedges.

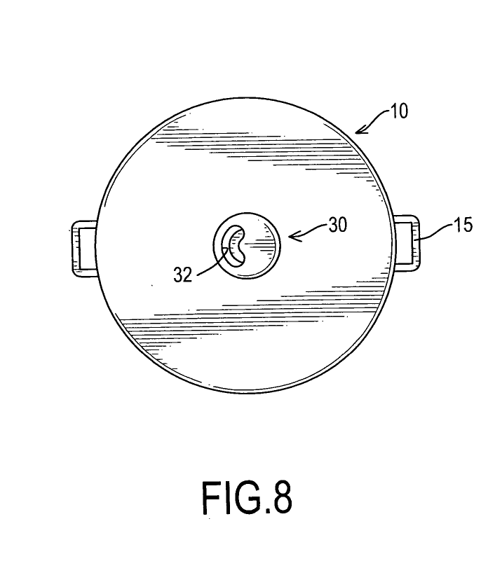

FIG. 8 shows another embodiment of the cap (10), wherein the cap (10) further has two ears (15) formed at two opposite sides of the cap (10) and adapted to secure with a belt to enable a user to conveniently carry the plastic beverage container.

According to the above description, several advantages are disclosed:

1. The filtering device is suitable for various kinds of plastic beverage container (50) since the cap (10) is attached by means of threads and most of the commonly available plastic beverage containers (50) have a regularly threaded opening (51) in standardization.

2. The filter elements (20) accommodated inside the plastic beverage container (50) do not take extra space inside a user's baggage. Therefore, the filtering device is conveniently portable.

3. The filtering device in the present invention is enabled to be used at any time and at any place to purify water for drinking to avoid users otherwise having to carry too much potable water with the baggage. For a mountain climber, using the filtering device to make sure the river water portable is a critical benefit to save physical strength.

Although the invention has been explained in relation to its preferred embodiment, many other possible modifications and variations can be made without departing from the spirit and scope of the invention as hereinafter claimed.

1. A filtering device for a portable beverage container, the filtering device comprising:
a cap (10) adapted to detachably mount on the portable beverage container and having a top face, a bottom face, a suction tube (12) extending from the top face, a recess formed in the bottom face, a connecting tube (14) formed on the bottom face inside the recess, and multiple ventilating holes (16) defined through the cap (10); and
at least one filter element (20) detachably attached to the connecting tube (14) to communicate with the suction tube (12) and adapted to be accommodated inside the portable beverage container, wherein each one of the at least one filter element (20) has a hollow shell, a filtering material (21) filling inside the shell, and multiple holes defined through the shell to allow water to pass through the filtering element (20).

2. The filtering device as claimed in claim 1, wherein the shell of each one of the at least one filter element (20) is cylindrical and has a top (23), a bottom end, an adjacent tube (22) formed on the top (23), and a bottom cover (25) attached to the bottom end of the shell;
wherein the bottom cover (25) is a cap-shaped body received inside the shell at bottom end and has a round top and a side wall formed around the round top to define a notch to engage with the adjacent tube (22) of an adjacent filter element (20).

3. The filtering device as claimed in claim 2, wherein the connecting tube (14) of the cap (10) and the adjacent tube (22) of the filter element (20) engaging with the cap (10) are engaged by means of wedges; and
the bottom cover (25) and the adjacent tube of the adjacent filter element (20) are engaged by means of wedges.

4. The filtering device as claimed in claim 2, wherein the bottom cover (25) of each one of the at least one filter element (20) is detachably engaged with the bottom end of the shell by means of threads.

5. The filtering device as claimed in claim 3, wherein the bottom cover (25) of each one of the at least one filter element (20) is detachably engaged with the bottom end of the shell by means of threads.

6. The filtering device as claimed in claim 1, wherein the cap (10) further has a movable hat (30) mounted on the suction tube (12), the movable hat (30) is cylindrical and has:
a round top, an opening, a side wall with an inner periphery formed around the round top, a water outlet (32) defined through the round top, a tab (31) formed on the inner periphery of the side wall, and a plug (33) formed under the round top to hermetically block the suction tube (12);
wherein the suction tube (12) further has a first end protruding out from the top face of the cap (10), a limiting cutout (13) defined around an outer periphery of the first end of the suction tube (12) to movably receive the tab (31) of the movable hat (30).

7. The filtering device as claimed in claim 1, wherein cap (10) further has an O-ring (45) attached on the bottom face of the cap (10) and a membrane (451) extending from the O-ring (45), to abut the bottom face of the cap (10) to detachably cover the multiple ventilating holes (16).

8. The filtering device as claimed in claim 6, wherein the cap (10) further has an O-ring (45) attached on the bottom face of the cap (10) and a membrane (451) extending from the O-ring (45), to abut the bottom face of the cap (10) to detachably cover the multiple ventilating holes (16).

9. The filtering device as claimed in claim 1, wherein the suction tube (12) further has an end extending from the bottom face of the cap (10) within the connecting tube (14).

10. The filtering device as claimed in claim 6, wherein the suction tube (12) further has a second end extending from the bottom face of the cap (10) within the connecting tube (14).

11. The filtering device as claimed in claim 1, wherein the filtering device has:
one filter element attached (20) to the cap (10); and
a resilient tube (60) engaging with filter element (20).

12. The filtering device as claimed in claim 2, wherein the filtering device has:
at least two filter elements (20) attached to the cap (10) in alignment; and
a resilient tube (60) engaging with a lowermost filter element among the at least two filter elements (20).

13. The filtering device as claimed in claim 1, wherein the cap (10) further has two ears (15) formed at two opposite sides of the cap (10) and adapted to secure with a belt to conveniently suspend the plastic beverage container (50).

14. The filtering device as claimed in claim 3, wherein the bottom cover (25) of each one of the at least one filter element (20) is detachably engaged with the bottom end of the shell by means of threads and wedges.

15. The filtering device as claimed in claim 5, wherein the bottom cover (25) further comprises:
a rectangular slit (254) having two long sides and two short sides formed under the round top, wherein each short sides has a dent defined at a distal edge of the short side; and
a pair of inclined cutouts (255) oppositely defined in edges around the opening in alignment with the two short sides.

16. The filtering device as claimed in claim 12, wherein the bottom cover (25) further comprises:
a rectangular slit (254) having two long sides and two short sides formed under the round top, wherein each short sides has a dent defined at a distal edge of the short side; and
a pair of inclined cutouts (255) oppositely defined in edges around the opening in alignment with the two short sides.
